(19) United States
(12) Patent Application Publication
(10) Pub. No.: US 2024/0273790 A1
(43) Pub. Date: Aug. 15, 2024

(54) Dynamic axes splitting and recombination for enhanced graphical data visualization and analysis

(71) Applicant: Minhong Mi, Newton, MA (US)

(72) Inventor: Minhong Mi, Newton, MA (US)

(21) Appl. No.: 18/629,751

(22) Filed: Apr. 8, 2024

Related U.S. Application Data
(60) Provisional application No. 63/444,894, filed on Feb. 10, 2023.

(51) Int. Cl. G06T 11/20; G06T 3/40; G06T 7/11

(52) U.S. Cl. CPC G06T 11/206; G06T 3/40; G06T 7/11

(57) ABSTRACT

Method and system are described for dynamic axes splitting and recombination within data visualization and analysis software, enabling enhanced interaction with graphical data. The invention facilitates the division of a chart into multiple sub-charts, each with independently auto-scaled axes, through user-initiated operations. Users can dynamically adjust the presentation by selecting graphs for individual or consolidated sub-chart display, rearrange graphs via drag-and-drop, and choose between vertical stacking or overlay configurations for sub-charts. This system significantly improves the granularity and flexibility of data analysis, allowing for detailed examination and comparison of diverse data sets within a single visualization framework. Applicable across various industries for analytical and reporting purposes, the method provides a transformative approach to navigating complex datasets, offering users unprecedented control and insight into their data visualization endeavors.

### TECHNICAL FIELD

This relates in general to the field of electric data processing, and more specifically to data visualization.

### BACKGROUND

In the domain of data visualization, the representation of complex data sets through graphical means is fundamental for the interpretation, analysis, and decision-making processes across various fields such as finance, science, engineering, and business analytics. Traditional visualization techniques often employ multiple graphs plotted within a unified chart, leveraging common axes to depict relationships and trends across different data sets. While effective for certain analyses, this conventional approach can limit the clarity and depth of insight attainable from densely populated or varied-scale data, as the fixed scale of shared axes may obscure subtle patterns or exaggerate discrepancies between data sets.

The challenge of effectively visualizing and analyzing data that spans a wide range of values or requires detailed examination of specific data subsets has prompted the need for more flexible and dynamic visualization tools. Existing solutions, such as the use of multiple y-axes or the creation of separate charts for each data set, offer partial remedies but often at the cost of increased complexity or reduced coherence in visual presentation. Furthermore, the static nature of these solutions fails to accommodate real-time interaction or the iterative exploration of data that modern analytical processes demand.

Against this backdrop, the ability to dynamically split and recombine chart axes—a technique allowing users to isolate and closely examine individual graphs on their own scaled axes within a single visualization—emerges as a significant innovation. This method not only enhances the granularity and precision of data analysis but also introduces a level of interactivity and adaptability previously unattainable in standard visualization practices. However, despite its apparent utility, the development and implementation of an effective axes splitting and recombination mechanism present unique technical and design challenges, notably in maintaining intuitive user interfaces and ensuring the seamless transition between combined and split views.

### SUMMARY

The present invention introduces method and system for the dynamic manipulation of axes in data visualization software, crucial for professionals in diverse sectors relying on such tools for insightful analysis and strategic decision-making. Designed for seamless integration with computer systems, it elevates the user experience by offering sophisticated mechanisms for both the display and interactive exploration of graphical data.

Central to the invention is the ability to initiate an axes splitting operation via user-friendly interface mechanisms, such as menu selections or toolbar buttons. This operation segregates multiple graphs within a chart into individual sub-charts, each with its own auto-scaled axes, arranged vertically with uniform presentation. This axes splitting feature is adaptable; it allows for the default creation of a separate sub-chart for each graph or, alternatively, the consolidation of selected graphs into fewer sub-charts based on user selection.

The dynamic aspect of the invention is highlighted by the ability to rearrange graphs between sub-charts through drag-and-drop actions, with the system automatically adjusting the layout and removing empty sub-charts. Additionally, an alternative overlay method is introduced, wherein sub-charts share the same spatial domain, offering a nuanced analysis of individual graphs by maintaining an independent y-axis for each sub-chart while sharing a common x-axis.

The invention further accommodates manual adjustments to the y-axis range of each sub-chart, providing flexibility for in-depth analysis. The reversion to the chart's original layout is facilitated through simple interface actions, allowing users to seamlessly toggle between detailed and consolidated views of the data.

Applications of this method span numerous sectors, including financial market analysis and healthcare research, where it enables a more precise examination of data by isolating performance metrics on separate axes or closely monitoring patient data across different scales.

The dynamic axes splitting and recombination technique introduced in this patent application represents a significant advancement in data visualization technology. It offers a flexible, intuitive, and detailed approach to data analysis, significantly benefiting fields where accurate and insightful data interpretation is crucial. The detailed operational mechanics, illustrated through flowcharts and examples, along with the practical applications, underline the versatility and innovation of the proposed system. While specific examples and terminologies are used for illustration, the scope of the invention is not limited to these, offering broad applicability and adaptability to various data visualization and analysis needs.

### BRIEF DESCRIPTION OF DRAWINGS

FIG. 1 illustrates a computing system in which the methodologies in accordance with the present invention may operate;

FIG. 2A illustrates an exemplary graphical data visualization with three line graphs in a two-dimensional Cartesian coordinate system according to the invention;

FIG. 2B illustrates the arrangement of the line graphs after an axes splitting operation is applied with the vertical stacking option according to the invention;

FIG. 2C illustrates an alternative arrangement of the line graphs after the axes splitting operation according to the invention;

FIG. 3A depicts two line graphs with vastly differing ranges of data values;

FIG. 3B illustrates the display of the line graphs after the axes splitting operation is applied with the overlay option according to this invention;

FIG. 4 displays a flowchart of the operational steps of the methodology of axes splitting and recombination according to this invention;

FIG. 5A presents the object hierarchy of a regular unified chart according to this invention; and

FIG. 5B reveals the object hierarchy of the chart after an axes splitting operation is applied according to this invention.

### DETAILED DESCRIPTION

The invention presents an advanced method for dynamic axes splitting and recombination within data visualization and analysis software, enabling enhanced interaction with graphical data visualizations.

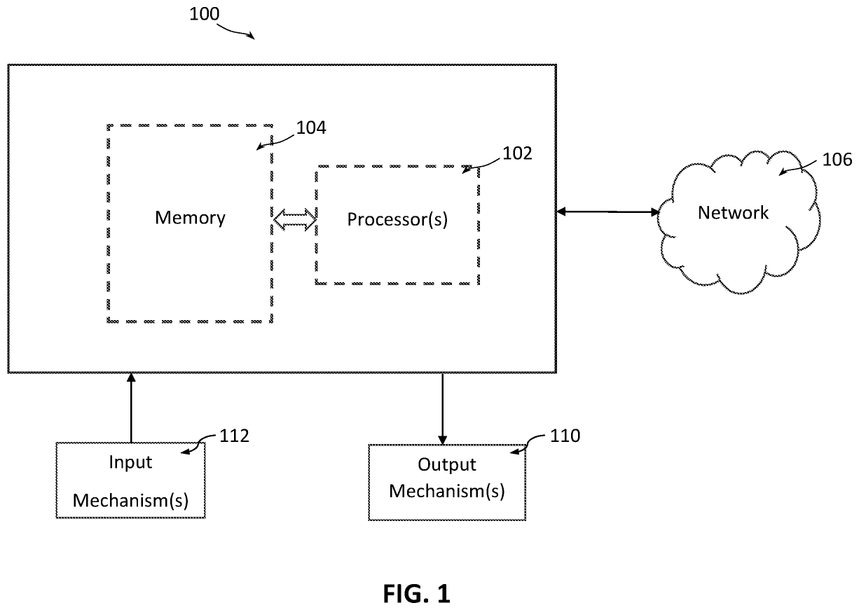

The provision of the method is facilitated by a computing system 100 as illustrated in FIG. 1, which is inclusively defined to encompass any device or amalgamation of devices equipped with at least one physical, tangible processor 102 and a corresponding physical, tangible memory 104. This memory 104, capable of storing executable instructions for the processor, may vary in form based on the computing system's design and purpose. Notably, the computing infrastructure can span across networked environments 106 incorporating multiple interconnected systems. Furthermore, the computing system 100 may include both output mechanisms 110 and input mechanisms 112. Output mechanism 110 could range from speakers and screens to more advanced options like holograms and virtual reality. Similarly, input mechanisms 112 may cover a wide spectrum, from mouses and touchscreens to various sensors and physical controls, adapting to the specific needs and functionalities of the computing system.

Subsequent details elucidate that the described methodologies are executable across various computing systems, guided by software-driven processes. These processes entail the execution of computer-readable instructions by one or more processors, thereby orchestrating the computing system's operations, including data manipulation. Such instructions are typically housed on computer-readable media, forming the basis of a computer program product.

Experts in the field will recognize the invention's compatibility with a broad spectrum of computing system configurations. These range from personal to mainframe computers, including portable devices, multi-processor systems, consumer electronics, network PCs, and even emerging technologies like wearables. The invention is equally applicable in distributed computing setups, where tasks are allocated across both proximal and distal computing entities interconnected via a mix of wired and wireless networks, with software modules distributed across local and remote storage devices.

Furthermore, the invention is adeptly suited for implementation within cloud computing environments, characterized by the dynamic allocation of computing resources over a network. This model supports various operational characteristics (like on-demand self-service and rapid elasticity) and service models, including SaaS, PaaS, and IaaS, across different deployment models such as private, public, and hybrid clouds. In essence, the description and claims encompass the employment of cloud computing as an integral environment for the invention's application.

Data visualization and analysis software are computer program products that serve as essential tools for professionals across industries to visually interpret and interact with data. If the data visualization and analysis software program were operated on the computer system 100 mentioned above, the data visualization would be displayed through the output mechanism 110 and users would be able to interact with the data visualization through the input mechanism 112.

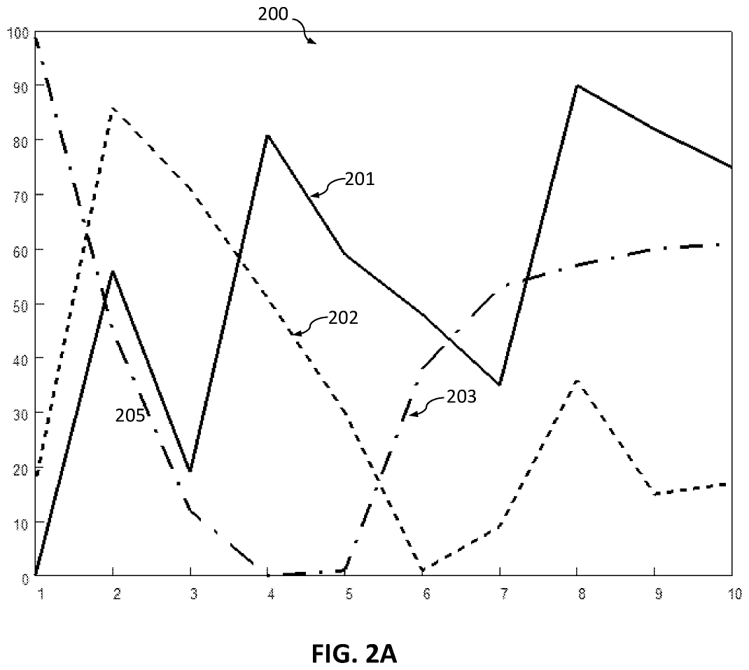

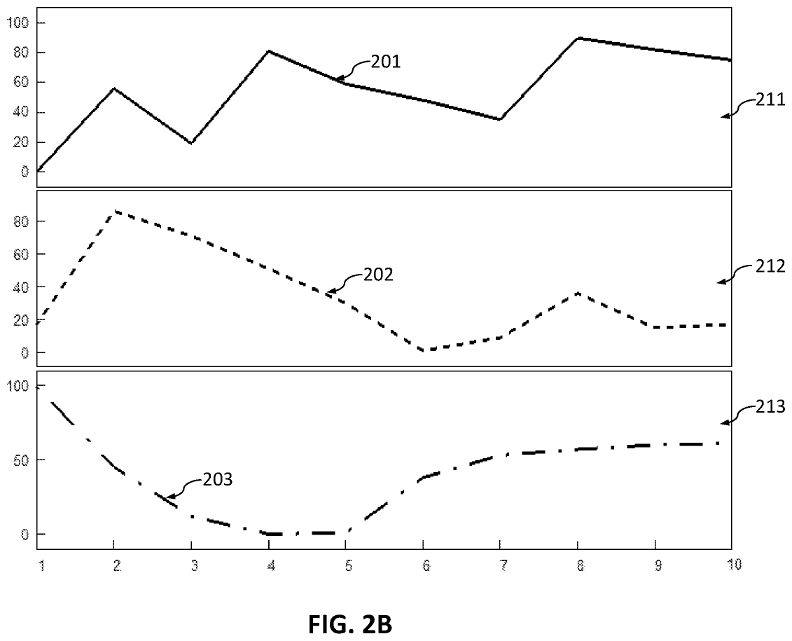

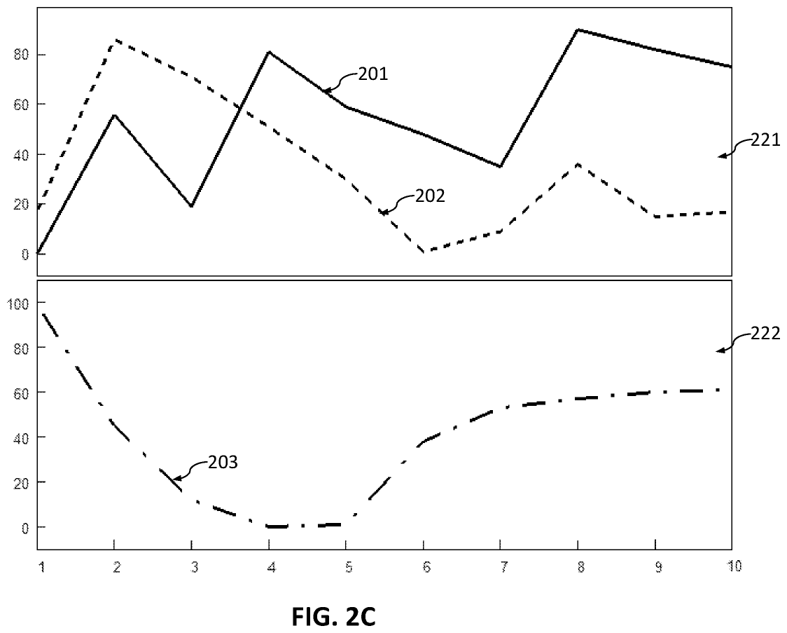

For clarification and demonstration purposes, an exemplary graphical data visualization generated by data visualization and analysis software is depicted in FIG. 2A. This figure illustrates a chart 200 containing three line graphs, designated as 201, 202, and 203, plotted within a two-dimensional Cartesian coordinate system. The initiation of an axes splitting operation is facilitated through user-friendly interface mechanisms, such as selecting options from a menu or clicking a toolbar button. As an innovative feature of this invention, subsequent to the axes splitting operation, each of the three line graphs is allocated to its own distinct chart axes, as exemplified in FIG. 2B. These newly formed chart axes 211, 212, and 213, henceforth known as sub-charts, are arranged vertically, each occupying equal height for uniform visual presentation. Notably, each sub-chart independently auto-scales to the data range of its corresponding graph, eschewing typical chart embellishments like titles and legends for a streamlined appearance.

In its default setting, the system generates a separate sub-chart for each graph present in the original chart upon performing the axes splitting operation. Enhancing user experience, a refined embodiment of this invention introduces an intuitive mechanism for adjusting the splitting process. Specifically, by selecting one or more graphs prior to splitting, the system consolidates the selected graphs into one sub-chart and segregates any unselected graphs into another, thereby creating just two sub-charts. FIG. 2C visualizes this refined approach, where graphs 201 and 202, having been selected pre-splitting, are grouped into the upper sub-chart 221, while the remaining unselected graph is placed into a lower sub-chart 222, illustrating the invention's flexibility in managing graph presentation.

The creation of sub-charts described above introduces a dynamic element to data visualization, allowing users to rearrange graphs between sub-charts through a simple drag-and-drop action. Should a sub-chart be emptied of graphs, it is automatically removed, its space reabsorbed by adjacent sub-charts, facilitating a fluid and customizable organization of graphs post-splitting. This dynamic restructuring capability is exemplified when transforming the initial arrangement shown in FIG. 2B into the configuration depicted in FIG. 2C, achieved by relocating graph 202 in sub-chart 212 to join graph 201 in the top sub-chart 211, demonstrating the method's adaptability and user-centric design.

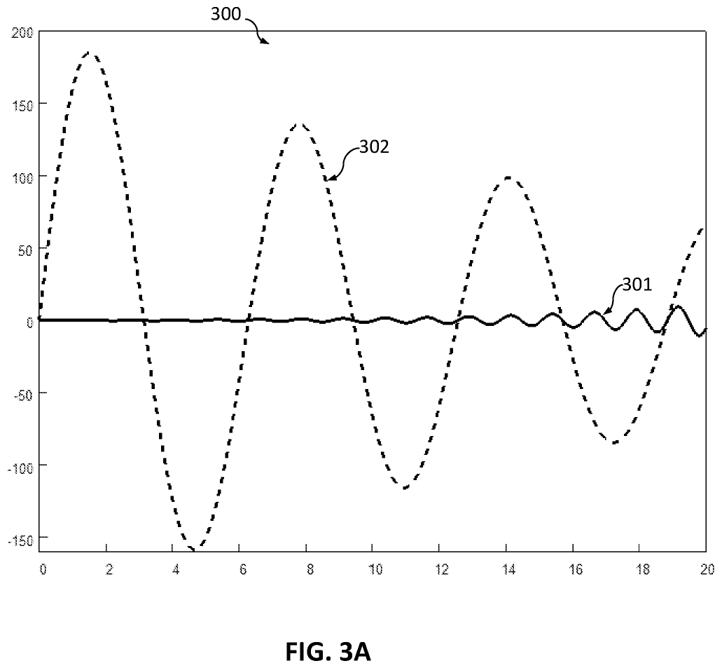

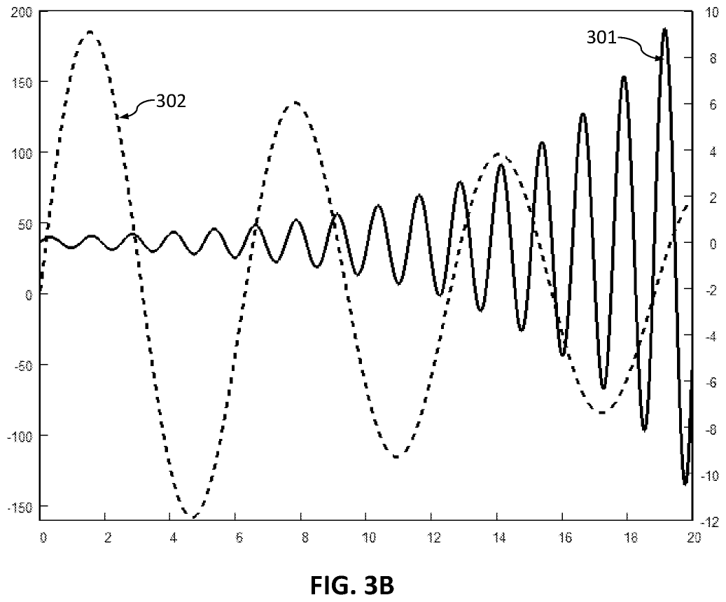

Beyond the vertical stacking of sub-chart following an axes splitting operation as previously outlined, the invention introduces a crucial alternative method for sub-chart arrangement. This method superimposes the sub-chart within the same spatial domain originally occupied by the unified chart. In this configuration, while each sub-chart maintains an independent y-axis, they collectively share a singular x-axis. The y-axis for each sub-chart is intelligently auto-scaled to accommodate the specific graph or graphs it represents. This overlay approach is exceptionally advantageous for users aiming for an in-depth examination of individual graphs within a chart that comprises multiple graphs that span vastly differing ranges of data values. Illustrations in FIGS. 3A and 3B depict a chart 300 containing two line graphs labeled as 301 and 302, demonstrating the visual transformation enabled by the axes splitting feature with the overlay option. This alternative arrangement allows for a nuanced analysis of each graph's details without the need to navigate away from the context of the combined data presentation, ensuring a seamless and insightful data exploration experience.

Following the division of the chart into sub-charts via the axes splitting method, each sub-chart's y-axis is automatically scaled to best fit the data displayed within. This initial auto-scaling ensures optimal visibility for the distinct graphs each sub-chart houses, enhancing the user's ability to discern detailed data points and trends at a glance. However, recognizing the need for flexibility in data analysis, this invention allows users to manually adjust the y-axis range of each sub-chart post-creation. This capability is crucial for in-depth data examination, as it affords analysts the autonomy to define their analytical focus, unhindered by the automatic scaling constraints. Although sub-charts generated with the overlay option share a common x-axis—necessitating uniform adjustments to the x-axis range across all such sub-charts—sub-charts arranged via the vertical stacking method boast individually tailored x-axes. These axes, while not explicitly shared, are designed to synchronize responsively with alterations in value ranges, ensuring that the data across vertically stacked graphs remains coherently aligned.

The process of reverting to the chart's original, unified layout is seamlessly facilitated through interface mechanisms akin to those employed during the axes splitting initiation. Options within a menu or toolbar button selections are examples of such mechanisms, providing a straightforward path for users wishing to consolidate their analysis back into a singular chart view. Executing this restoration operation effectively conceals all sub-charts derived from the splitting process, reintegrating the displayed graphs into their initial combined state within the chart area. This recombination not only preserves the original data visualization context but also offers users the flexibility to toggle between consolidated and detailed views as their analytical needs evolve.

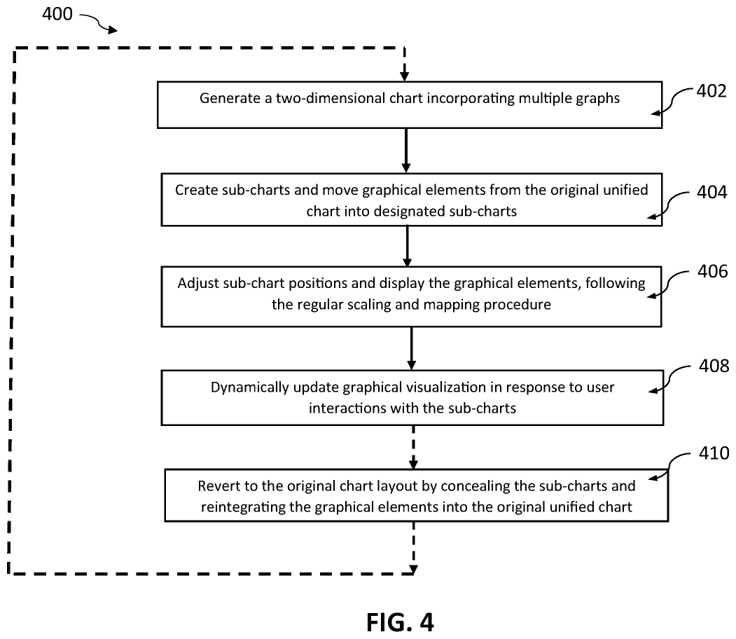

Having introduced the methodology's visual components and capabilities with practical illustrations, we now elucidate the operational mechanics, guided by the flowchart illustrated in FIG. 4. This diagram is instrumental in clarifying the sequence of actions undertaken by the system.

The procedure begins, as illustrated in block 402, with the generation of a two-dimensional chart incorporating multiple graphs. While the examples provided primarily feature line graphs, it is essential to underscore the method's broad applicability to a diverse array of graphical representations, including scatter plots, bar graphs, and stem graphs, among others. The system is designed to accommodate any number of graphs within a chart, directly influencing the resultant number of sub-charts following an axes splitting operation.

Block 404 outlines the axes splitting process, where the system transitions graphical elements from the original unified chart into designated sub-charts. By default, the system generates a unique sub-chart for each individual graph; however, if the user has pre-selected specific graphs, the system then consolidates these into one sub-chart, segregating the remaining unselected graphs into another. This delineates a clear user-driven customization capability in organizing data visualizations.

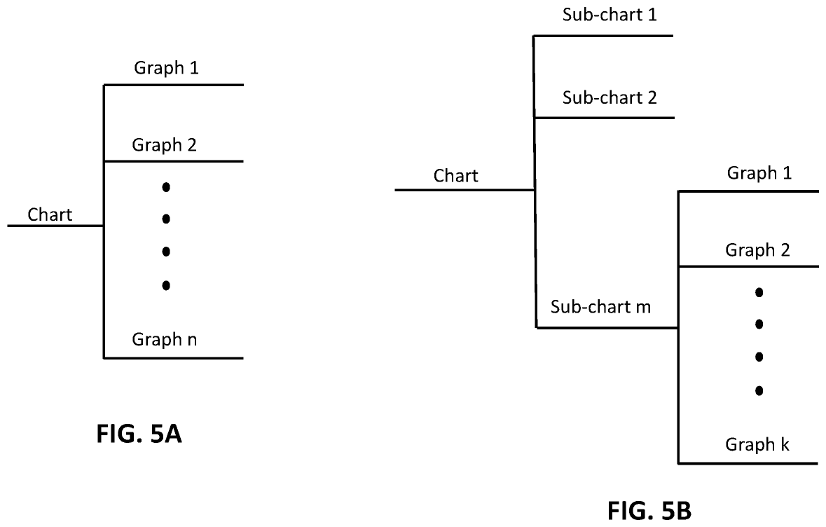

From a structural perspective, as delineated in FIG. 5A, graphical elements are initially nested within the unified chart. Post-splitting, as shown in FIG. 5B, these elements are repositioned as constituents of the new sub-charts, which are themselves nested within the original chart framework. This reorganization transforms the initial chart into a master chart, serving primarily as an overarching container for the sub-charts, rather than the direct repository of graphical elements.

Subsequently, block 406 details the procedure for adjusting the sub-charts' positions and displays after allocation. When opting for vertical stacking, each sub-chart is allocated an equal segment of the master chart's vertical dimension. Conversely, with the overlay option, sub-charts share the same display area as the master chart. This phase includes scaling and mapping of the graphical elements I each sub-chart to accurately render them on the display, akin to standard chart displays.

Block 408 describes the system's response to user interactions with the sub-charts, implementing a dynamic visualization update process. This includes harmonizing the value range along the X-axis across all sub-charts and rearranging sub-chart layouts following the repositioning of graph objects via drag-and-drop actions, specifically within the context of vertical stacking.

Finally, block 410 captures the mechanism enabling users to revert to the original chart layout. This entails concealing the sub-charts generated during the splitting process, reintegrating the graphical elements into the unified chart, and reinstating them using the pre-splitting scaling and mapping protocols. Highlighted by dashed lines, this recombination—and the potential repetition of the splitting operation—provides users the versatility to oscillate between comprehensive and granular data views, enriching the user experience with enhanced analytical flexibility.

The innovative method of dynamic axes splitting and recombination has a wide array of practical applications across various sectors that rely heavily on data visualization and analysis software for decision-making and reporting. One notable application is in financial market analysis, where analysts often track and compare multiple financial instruments simultaneously. By utilizing axes splitting, analysts can isolate the performance of individual stocks or indices on separate y-axes, enabling a more precise comparison without the interference of vastly different value ranges. This method allows for the detailed examination of subtle trends and patterns in individual securities or market sectors, potentially unveiling investment opportunities or risks that may not be evident in a combined chart view. Furthermore, the ability to dynamically recombine axes facilitates a quick return to a holistic market overview, providing a versatile tool for both detailed analysis and broader market surveillance.

Another compelling application lies in the field of healthcare and biomedical research, where researchers deal with complex datasets spanning various measurement scales, such as patient vital signs, lab test results, and genomic data. The axes splitting method can significantly enhance the visualization of patient cohorts, enabling researchers to dissect and analyze data with varying magnitudes and units of measure on individualized scales. For instance, in a longitudinal study of disease progression, researchers can use this method to closely monitor specific biomarkers or symptoms within subgroups of patients, adjusting axes dynamically to focus on relevant data ranges. This capability not only aids in the identification of subtle correlations and trends but also supports the customization of visualizations to address specific research questions or hypotheses, thereby advancing scientific inquiry and personalized medicine.

In both examples, the dynamic axes splitting and recombination method offers a transformative approach to data visualization, enabling users to navigate and interpret complex datasets with an unprecedented level of flexibility and detail. This innovative technique stands to benefit any field where data-driven insights are critical, paving the way for more nuanced analyses and informed decisions.

While the content discussed has been detailed using terminology specific to computer structure, methods, and computer-readable formats, it should be noted that the invention outlined in the claims attached is not confined to the particular details mentioned. Instead, these details are provided as illustrative examples of how the claims might be realized.

The subject matter outlined above is intended purely for illustrative purposes and should not be seen as restrictive. It is possible to apply various alterations and modifications to the described content without straying from the example embodiments and applications presented, and without deviating from the genuine essence and breadth of the current invention, as delineated in the subsequent claims.

What is claimed is:

1. A computer implemented method for dynamically splitting and recombining axes in a data visualization system to facilitate enhanced analysis and interaction with graphical data visualizations, the method comprising:
generating a two-dimensional chart within a computing device, the chart capable of displaying a plurality of graphical representations, wherein the graphical representations include at least one of scatter plots, line graphs, bar graphs, and stem graphs, and wherein the chart is configured to display an unlimited number of said graphical representations simultaneously;
initiating an axes splitting operation in response to a user command, wherein said operation divides the original chart into multiple sub-charts, each sub-chart created to host at least one graphical representation from the plurality of graphical representations;
reassigning graphical representations from the original chart to the corresponding sub-charts, wherein each graphical representation becomes a child object of its respective sub-chart, and wherein each sub-chart is further defined as a child of the original chart, thereby establishing a hierarchical structure;
updating the display properties and positions of the sub-charts within the original chart's display area, wherein each sub-chart undergoes scaling and mapping procedures to accurately render its contained graphical representations;
dynamically updating the sub-charts in real-time based on user interactions, including adjusting the value range along at least one axis across all sub-charts and modifying the layout of sub-charts upon the repositioning of graphical representations through drag-and-drop actions; and
reverting the sub-charts to a unified chart layout upon receiving a user command to recombine axes, wherein the process involves hiding or removing the sub-charts, reassigning the graphical representations back to the original chart, and applying the original scaling and mapping procedures to display the graphical representations within the unified chart area.

2. The method of claim 1, wherein the sub-charts are generated based on either a default mode that creates one sub-chart per graphical representation or a selective mode that groups selected and non-selected graphical representations into at least two sub-charts.

3. The method of claim 1, wherein the sub-charts are arranged according to a user-selected configuration including a vertical stacking option, wherein each sub-chart occupies an equal segment of the master chart's vertical dimension, and an overlay option, wherein all sub-charts share the same display area as the master chart.

4. The method of claim 3, wherein sub-chart layouts are automatically updated with empty sub-charts removed following the repositioning of graph objects via drag-and-drop actions across sub-charts created with the vertical stacking option.

5. The method of claim 1, wherein a user can toggle between consolidated and detailed views of graphical data for enhanced data visualization and analysis.

6. A computer system comprising:
a processor; and
a computer-readable storage medium having computer-executable instructions stored thereon which, when executed by a computer, cause the apparatus to perform operations comprising:
generating a two-dimensional chart within a computing device, the chart capable of displaying a plurality of graphical representations, wherein the graphical representations include at least one of scatter plots, line graphs, bar graphs, and stem graphs, and wherein the chart is configured to display an unlimited number of said graphical representations simultaneously;
initiating an axes splitting operation in response to a user command, wherein said operation divides the original chart into multiple sub-charts, each sub-chart created to host at least one graphical representation from the plurality of graphical representations;
reassigning graphical representations from the original chart to the corresponding sub-charts, wherein each graphical representation becomes a child object of its respective sub-chart, and wherein each sub-chart is further defined as a child of the original chart, thereby establishing a hierarchical structure;
updating the display properties and positions of the sub-charts within the original chart's display area, wherein each sub-chart undergoes scaling and mapping procedures to accurately render its contained graphical representations;
dynamically updating the sub-charts in real-time based on user interactions, including adjusting the value range along at least one axis across all sub-charts and modifying the layout of sub-charts upon the repositioning of graphical representations through drag-and-drop actions; and
reverting the sub-charts to a unified chart layout upon receiving a user command to recombine axes, wherein the process involves hiding or removing the sub-charts, reassigning the graphical representations back to the original chart, and applying the original scaling and mapping procedures to display the graphical representations within the unified chart area.

7. The computer system of claim 6, wherein the sub-charts are generated based on either a default mode that creates one sub-chart per graphical representation or a selective mode that groups selected and non-selected graphical representations into at least two sub-charts.

8. The computer system of claim 6, wherein the sub-charts are arranged according to a user-selected configuration including a vertical stacking option, wherein each sub-chart occupies an equal segment of the master chart's vertical dimension, and an overlay option, wherein all sub-charts share the same display area as the master chart.

9. The computer system of claim 8, wherein sub-chart layouts are automatically updated with empty sub-charts removed following the repositioning of graph objects via drag-and-drop actions across sub-charts created with the vertical stacking option.

10. The computer system of claim 6, wherein a user can toggle between consolidated and detailed views of graphical data for enhanced data visualization and analysis.
